(19) United States
(12) Patent Application Publication
(10) Pub. No.: US 2011/0157458 A1
(43) Pub. Date: Jun. 30, 2011

(54) METHOD AND APPARATUS FOR FOCUSING

(75) Inventors: JIN-LIANG CHEN, Hsinchu City (TW); Chun-Chieh Wang, Taoyuan County (TW); Hau-Wei Wang, Taipei County (TW); Shih-Hsuan Kuo, Hsinchu County (TW); Leh-Rong Chang, Taipei City (TW); Huang-Wen Lai, Taipei County (TW)

(73) Assignee: Industrial Technology Research Institute, Hsinchu (TW)

(21) Appl. No.: 12/835,521

(22) Filed: Jul. 13, 2010

(30) Foreign Application Priority Data
Dec. 25, 2009 (TW) 098144927

(51) Int. Cl. G03B 13/18; G01J 3/28

(52) U.S. Cl. 348/357; 356/328; 348/E05.045

(57) ABSTRACT

The present disclosure provides a method and system for focusing, which modulates a broadband light into a dispersive light having a higher dispersion characteristic and a lower dispersion characteristic, and the dispersion light is projected onto an object so as to form an object light. By means of the filtering and dividing procedure, a first optical spectrum of the dispersion light with respect to the higher dispersion characteristic is utilized to detect a height information of the surface profile of the object. Then, according to the height information, a second optical spectrum of the dispersion light with respect to the lower dispersion characteristic is adjusted to focus onto the object so that an imaging sensing device is capable of sensing the object light with respect to the lower dispersion characteristic, and thereby obtaining a clear and focusing image corresponding to the surface of the object.

### TECHNICAL FIELD

The present disclosure relates to an optical detection technique, and more particularly, to a method and apparatus for instant auto-focus based upon optical chromatic dispersion principle.

### TECHNICAL BACKGROUND

With rapid advance in the flat panel display (FPD) manufacturing technology, the demand for better quality control in the manufacturing of the flat panel display including the array process, the cell process and the color filter process is increasing. That is because the ability to detect deflects in an on-line and real-time manner can significantly affect the manufacturing of the flat panel display with respect to the production yield and the production cost.

Generally, development and application of FPD have been accelerated in accordance with increase of the dimensions. To increase the productivity and ensure the low cost of large-size FPD production, many efforts have been continued for accelerating each and every process to be performed in the FPD production as well as for speeding up its inspection procedure for determining good/fail and rework of a flat panel display. However, with the increasing of FPD dimension, larger glass substrates will be required and used for producing the same so that there will be severe substrate deflection problems to be solved during the production. Nevertheless, for inspecting those large-size glass substrates, the performance of a conventional automatic optical inspection system (AOI) may not be satisfactory since its focus range is comparatively not larger enough for those large-size glass substrates and also its focus search speed is not fast enough, and consequently, the execution of posterior processes in the FPD production after each inspect will be adversely affected.

Essentially, there are two types of focusing techniques, which are active focusing and passive focusing. The passive focusing can be illustrated in the technique disclosed in TW Pat. Pub. No. TW00486599, in which the focus search is performed in two stages, i.e. a fast search stage and a fine search stage. Moreover, in TW Pat. Pub. TW00571583, the focus search is performed based upon depth of field and also for enabling an auto focus process to be performed in short stroke, its focus search range is defined. For active focusing, it can be exemplified by the AF-I auto focus apparatus from Chuo Precision Industrial Co., Ltd. The AF-I auto focus apparatus is operated based on a phase comparison between an original grating image and another grating image resulting from the reflection of an object whereas the reflected grating image is generated by the projection of a beam from a light source to travel passing a grating and then through an objective lens so as to illuminate onto a surface of the object. In addition, In U.S. Pat. No. 7,477,401, the measuring of surface topography of an object and two-dimensional microscope imaging of the object are performed using two different light sources according to light dispersion principle.

### TECHNICAL SUMMARY

In an exemplary embodiment, the present disclosure provides a method for focusing in a focusing apparatus, which comprises the steps of: providing a dispersion module characterized by a dispersion curve including a first dispersive band and a second dispersive band; enabling a broadband light to travel passing through the dispersion module so as to form a dispersion light in a manner that the dispersion light is projected on an object so as to form an object light; analyzing the spectrum of the object light at a portion thereof relating to the first dispersive band for obtaining a height information of the surface profile of the object; enabling the portion of the dispersion light relating to the second dispersive band to focus onto the object according to the height information; and sensing the object light at a portion thereof relating to the second dispersive band so as to obtain a focused image.

In another exemplary embodiment, the present disclosure provides an apparatus for focusing, which comprises: a light source module, for providing a broadband light; a dispersion module, characterized by a dispersion curve including a first dispersive band and a second dispersive band, provided for modulating the broadband light into a dispersive light; an objective lens, for focusing the dispersive light while projecting the same onto an object so as to form an object light; a beam splitting/filtering element, for splitting the object light into a first object beam and a second object beam while filtering the two so as to form a first filtered beam corresponding to the first dispersive band and a second filtered beam corresponding to the second dispersive band; an analyzer, for performing a spectrum analysis operation upon the first filtered beam so as to obtain a central wavelength relating to a height information of the surface profile of the object; a control unit, for performing a calculation according to the central wavelength so as to obtain the height information to be used for adjusting the distance between the objective lens and the object and thus enabling the portion of the dispersion light relating to the second dispersive band to focus onto the object; and an image sensor, for sensing the second filtered beam so as to form a focused image.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a flow chart depicting steps of a method for focusing in a focusing apparatus according to an embodiment of the present disclosure.

FIG. 2A to FIG. 2D are schematic diagrams illustrating various dispersion curves.

FIG. 2E is a schematic diagram showing how a band within a specific wavelength range in the dispersion curve of FIG. 2D is specified to be the second dispersive band.

FIG. 3 is a schematic diagram showing how a dispersive light is focused in the present disclosure.

FIG. 4A is a flow chart depicts steps performed in spectrum analysis for obtaining a height information of the surface profile of the object in the present disclosure.

FIG. 4B is a schematic diagram showing how a dispersive light field is projected on the surface of the object in the present disclosure.

FIG. 4C is a diagram illustrating the relationship between light intensity and wavelength obtained from a reflection field analysis of a spectroscopy.

FIG. 5 is a flow chart depicts steps performed in an image sensor for forming a clear focused image in the present disclosure.

FIG. 6 is a schematic diagram showing an apparatus for focusing according to a first embodiment of the present disclosure.

FIG. 7 is a schematic diagram showing an apparatus for focusing according to a second embodiment of the present disclosure.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

The method for focusing in a focusing apparatus of the present disclosure is designed basing upon optical chromatic dispersion principle, by which a height information relating to the surface profile of an object can be obtained from a spectrum analysis, which is constructed for analyzing a reflected light originated from the projection of a dispersion light onto the object. In the spectrum analysis, the wavelength of a part of the reflected light, whose energy level is the highest or where most energy of the reflected light is concentrated thereat, is located and used for obtaining the height information of the object. Thereafter, according to the height information, a portion of the dispersion light with respect to the lower dispersion characteristic can be adjusted to focus onto the object. Since the method of the present disclosure is able to perform a focus searching operation without having to enable relating lens module to move along its optical axis direction and also without having to calculate image information, the time required for the focus searching can be greatly reduced. Moreover, in the dispersion module designed for the present focusing method, there is a proper focus search range being defined thereon in a flexible manner, which can be a range between several hundreds of μm and several millimeters, and also the focusing of the dispersion module is able to reach μm-scale precision. Thus, the method for focusing in a focusing apparatus of the present disclosure is advantageous in its comparatively larger focus search range and fast focus search speed, i.e. less than 0.2 second.

The present disclosure also provides an apparatus for focusing, which adopts an optical design of chromatic dispersion module and spectroscopy. It is noted that the light source for the focusing apparatus of the present disclosure is the one capable of emitting light composed of beams of various wavelengths, or is a broadband light source. By the dispersion module and the objective lens configured in the focusing apparatus of the present disclosure, the broadband light emitted from the light source are divided into beams of different wavelengths and focused on different focused positions of different depths before being projected on the object. That is, the broadband light are divided into beams of different wavelengths that are to be focused on the object at positions of different depths. Thereafter, by analyzing the spectrum of the light reflected from the object for obtaining the relationship between light intensity and wavelength, a height information relating to the surface profile of the object can be obtained. The height information is then being transmitted to a control unit to be used as base for controlling an actuator to adjust the distance between the object and the objective lens, by that the spectrum of the dispersion light with respect to the lower dispersion characteristic is adjusted to focus onto the object's surface, and thus, by the use of an imaging sensing device constructed for sensing the reflected light of lower dispersion characteristic, a clear and focusing image corresponding to the surface of the object can be obtained. Thereby, with the apparatus for focusing of the present disclosure, the operation of surface defect inspection can be performed with improved stability.

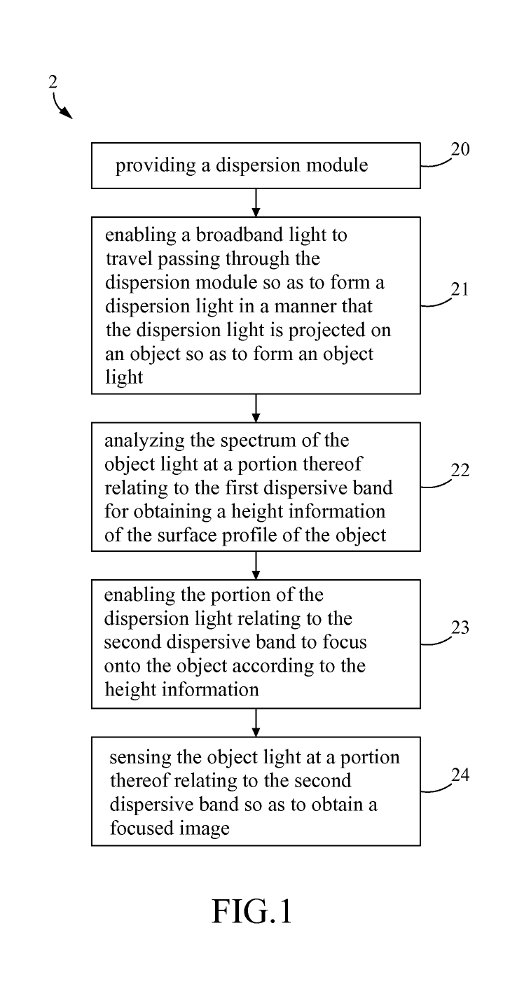

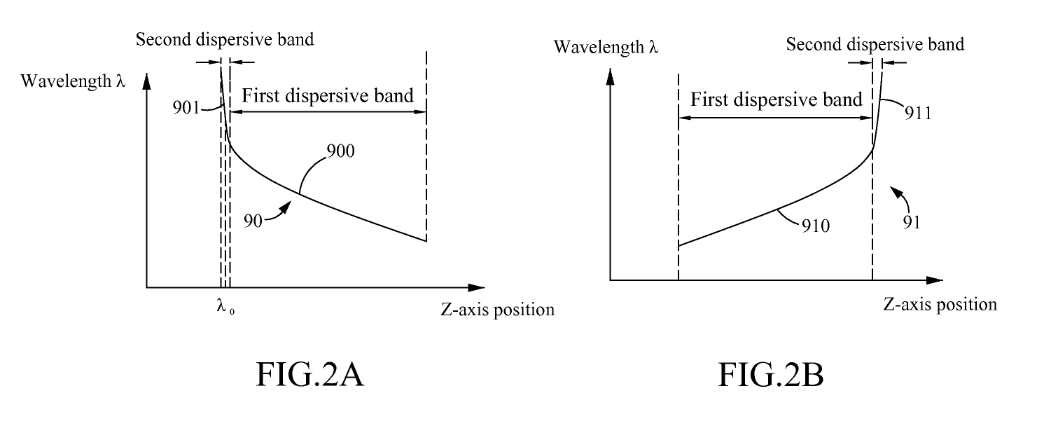

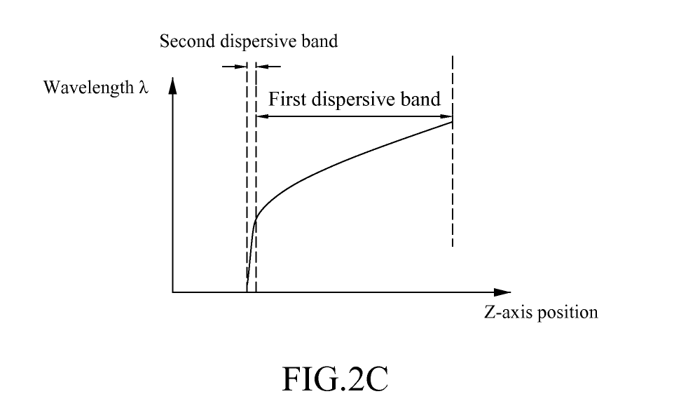

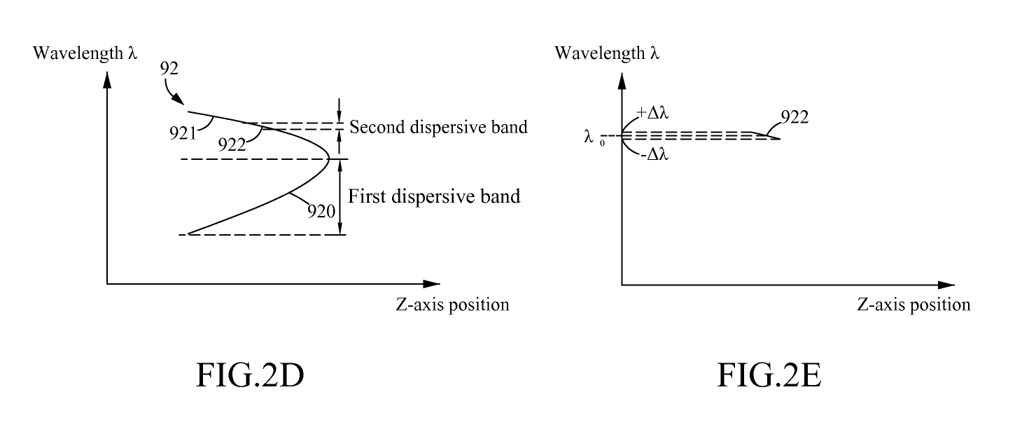

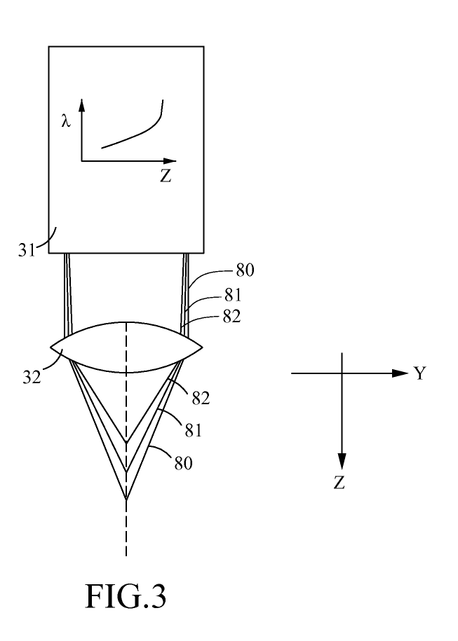

Please refer to FIG. 1, which is a flow chart depicting steps of a method for focusing in a focusing apparatus according to an embodiment of the present disclosure. As shown in FIG. 1, the flow starts from step 20. At step 20, a dispersion module, being characterized by a dispersion curve including a first dispersive band and a second dispersive band, is provided for causing axial chromatic dispersion to a broadband light projected on the dispersion module with respect to the difference in wavelength as the broadband light is composed of beams of various wavelengths; and then the flow proceeds to step 21. Please refer to FIG. 2A to FIG. 2D, which are schematic diagrams illustrating various dispersion curves. The vertical axes in FIG. 2A to FIG. 2D represent wavelength and the horizontal axes represent the height in Z-axis direction. In FIG. 2A, the dispersive curve 90 is composed of two curve sections 900, 901, in which the dispersion range of the curve section 900 is larger than that of the other curve section 901, i.e. the curve section 900 is located inside a band of higher dispersion characteristic and thus is referred hereinafter as a first dispersive band, and the curve section 901 is located inside a band of lower dispersion characteristic and thus is referred hereinafter as a second dispersive band. Thereby, when the broadband light is traveling passing the dispersion module, the portion of the light whose wavelengths are located inside the range defined by the first curve section 900 is scattered for dispersing beams of different wavelengths to focus on different Z-axis positions with respect to the first curve section 900. On the other hand, as the second curve section 901 is characterized by lower dispersive characteristic, the portion of the light whose wavelengths are located inside the range defined by the second curve section 901 will not be scattered as much as those corresponding to the first curve section 900, and are focused within a specific height range.

The dispersive curve shown in FIG. 2B is basically the same as the one shown in FIG. 2A, but is different in that: in FIG. 2A, the dispersion range of the curve section 901 is smaller than that of the other curve section 900, but in FIG. 2B, since the dispersion range of the curve section 910 in the dispersive curve 91 is larger than that of the other curve section 911, the curve section 910 is therefor referred as the first dispersive band and the curve section 911 is referred as the second dispersive band. In addition, the dispersive curve shown in FIG. 2C is also similar to the one shown in FIG. 2A, but it's different in that: the wavelengths that the first dispersive band and the second dispersive band in FIG. 2B are corresponding to are different from those in FIG. 2A, i.e. the wavelengths of the beams being dispersed according to the curve section define by the first dispersive band are longer than those being dispersed according to the curve section defined by the second dispersive band.

In FIG. 2D, the dispersive curve 92 can be divided into an upper curve sections 920 and a lower curve section 921. It is noted that both of the two curve sections 920, 921 are curves with high dispersion characteristic, but are designed to cause opposite chromatic dispersion effects. In this embodiment, the lower curve section 920 is selected to be the first dispersive band while defining a portion of the upper curve section 921 within a specific wavelength range 922, i.e. λ₀±Δλ to be the second dispersive band, as shown in FIG. 2E. According to the first dispersive bands shown in FIG. 2A to FIG. 2D, the beams whose wavelengths are located inside the range defined by those first dispersive bands are distributed at different Z-axis positions in a wide range so that the construction of the first dispersive band in the present disclosure is used for detecting the height information relating to the surface profile of the object. However, as the second dispersive band has lower dispersion characteristic, the construction of the second dispersive band in the present disclosure is used for forming a clear and focused image of the object.

After the completion of the step 20, the flow will proceed to step 21, as shown in FIG. 1. At step 21, a broadband light is projected to travel passing through the dispersion module so as to form a dispersion light in a manner that the dispersion light is projected on an object for forming an object light; and then the flow proceeds to step 22. In this embodiment of the present disclosure, the broadband light is emitted from a broadband light source, such as white light source, which is constructed for projecting the broadband light toward the dispersion module. Please refer to FIG. 3, which is a schematic diagram showing how a dispersive light is focused in the present disclosure. It is noted that the dispersion of the dispersion module 31 can be defined by any one of the dispersive curves shown in FIG. 2A, FIG. 2B, FIG. 2C or FIG. 2D. In this embodiment, the dispersion of the dispersion module 31 is governed by the dispersive curve 91 shown in FIG. 2B. As shown in FIG. 3, the beams 80, 81, 82 whose wavelengths are located inside the range defined by the first dispersive band 91 are distributed at different Z-axis positions. After being dispersed, the beams 80, 81, 82 will be focused by the objective lens 32 at different focused positions of different depths according to the differences in wavelengths. In FIG. 3, when the beam 80 represents a red beam (R), the beam 81 represents a green beam, and the beam 82 represents a blue beam (B), the depth of the focused position of the beam 80 is the largest while the beam 82 is the smallest and the beam 81 is at the middle of the two.

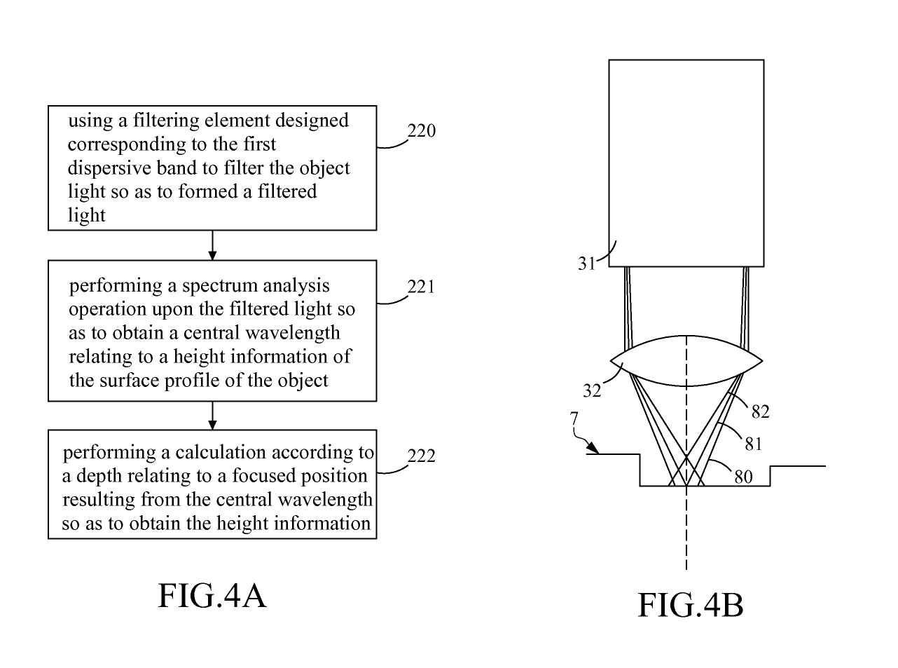

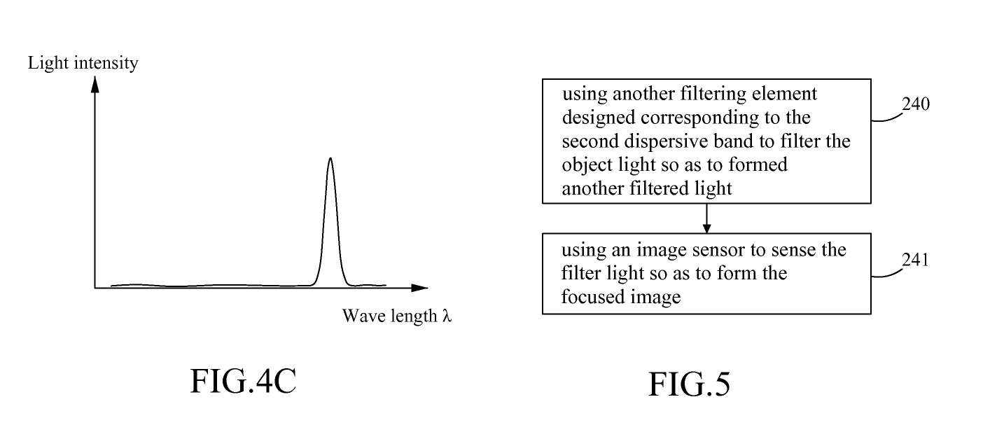

After the completion of the step 21, the flow will proceed to step 22, as shown in FIG. 1. At step 22, the spectrum of the object light at a portion thereof relating to the first dispersive band is analyzed for obtaining a height information of the surface profile of the object; and then the flow proceeds to step 23. Please refer to FIG. 4A, which is a flow chart depicts steps performed in spectrum analysis for obtaining a height information of the surface profile of the object in the present disclosure. As shown in FIG. 4A, the spectrum analysis process starts from step 220. At step 220, a filtering element designed corresponding to the first dispersive band is used to filter the object light so as to formed a filtered light; and then the flow proceed to step 221. Basing upon the aforesaid chromatic dispersion principle, the height information relating to the surface profile of the object can be determined according to the intensity distribution resulting from the dispersion corresponding to the first dispersive band. Accordingly, the filtering element used in the step 220 should be a filter capable of allowing the beams of wavelengths corresponding to the first dispersive band to pass therethrough while blocking the others. For instance, when the dispersive curve in this embodiment is the curve selected from that in FIG. 2A or FIG. 2B, the filtering element used in the step 220 should be a low-pass filter, on the other hand, if the dispersive curve in this embodiment is the curve shown in FIG. 2C, the filtering element used in the step 220 should be a high-pass filter. At step 221, a spectrum analysis operation is performed upon the filtered light so as to obtain a central wavelength relating to the height information of the surface profile of the object; and then the flow proceeds to step 222. It is noted that the central wavelength is a wavelength selected from the group consisting of: the wavelength corresponding to the maximum light intensity of the filtered light, and the wavelength with representative height information that is obtained from a numerical calculation. In this embodiment, the central wavelength is selected to be the wavelength corresponding to the maximum light intensity of the filtered light. Please refer to FIG. 4B, which is a schematic diagram showing how a dispersive light field is projected on the surface of the object in the present disclosure. As shown in FIG. 4B, the beams of different wavelengths projected on an object's surface will be reflected differently since they are focused at different focused positions of different depths. In the embodiment shown in FIG. 4B, only the beam 81 is focused right on the surface of the object 7 and the others are not, so that, in a spectroscopy, the intensity distribution of the reflected filtered light with respect to wavelengths can be shown as the one illustrated in FIG. 4C.

In FIG. 4C, an optical signal relating to the maximum light intensity of the filtered light can be detected by the use of a spectroscope, and thereby, the wavelength corresponding to the maximum light intensity is defined to be the wavelength of the beam 81 since the beam 81 is the only beam that is focused right on the surface of the object 7 and the others are not. After the wavelength corresponding to the maximum light intensity is obtained from the performing of step 221, the flow proceeds to step 222. At step 222, a calculation is performed according to a focused depth relating to the position resulting from the central wavelength, i.e. the wavelength obtained from the step 221, so as to obtain the height information of the object 7. That is, as the depths of the focused positions for the beams of different wavelengths that are caused by the dispersion module can be detected and measured in advance, the specific depth relating to the focused position corresponding to the wavelength corresponding to the maximum light intensity can be obtained as soon as the central wavelength is determined. Thereby, the height information relating to the surface profile of the object can be calculated from the so-obtained depth relating to the specific focused position and the distance between the object and the lens whereas the distance between the object and the lens can be easily measured.

After the height information relating to the surface profile of the object is obtained, the flow proceeds to step 23. At step 23, an operation is performed according to the height information for enabling the portion of the dispersion light relating to the second dispersive band to focus onto the object; and then the flow proceeds to step 24. The purpose of the step 23 is to achieve a clear and focused surface image of the object. Operationally, since the height information relating to the surface profile of the object is already obtained in the step 22, the object can be moved by one movement to a position corresponding to the focused positions of the beams included in the second dispersive band. Taking the dispersive curve of FIG. 2A for example, although the beams whose wavelengths are located in the specific wavelength range are considered to be the beams of the second dispersive band, this specific wavelength range is so small with respect to the depths variation relating to the different focused positions resulting from the beams of the second dispersive band, so that the influence caused thereby can be ignored, and thus can be represented by the central wavelength λ₀. Thus, By the use of a linear actuator, such as a liner motor or piezoelectric driver, for controlling either the object or the objective lens to move so as to adjust the distance between the two, the beam relating to the central wavelength λ₀ can be focused on the surface of the object. At step 24, an image sensor is used for sensing the object light at a portion thereof relating to the second dispersive band so as to obtain a focused image. Please refer to FIG. 5, which is a flow chart depicts steps performed in an image sensor for forming a clear focused image in the present disclosure. In the flow for obtaining a clear and focused image illustrated in FIG. 5, the flow starts from the step 240. At step 240, a filtering element designed corresponding to the second dispersive band is used to filter the object light so as to formed a filtered light; and then the flow proceeds to step 241. Since the beams relating to the second dispersive band are already focused on the surface of the object, a clear image of the object can be obtained simply by sensing the beams reflected from the surface of the object. Moreover, since the beams of the second dispersive band are beams with low dispersion characteristic, there will be no aberration being resulted thereby. Thus, the filtering element used in the step 240 can be selected to be a high-pass filter or a low-pass filter according to the structure of the dispersive curve so as to allow only the beams of the second dispersive band to pass therethrough. For instance, when the dispersive curve is the one illustrate in FIG. 2D, a band-pass filter is used as the filtering element in the step 240 for allowing the beams whose wavelengths are ranged between λ₀±Δλ to pass therethrough. At step 241, an image sensor is used to sense the filter light so as to form the focused image, whereas the image sensor can be a complementary metal-oxide-semiconductor (CMOS) image sensor or a charged coupled device (CCD) image sensor.

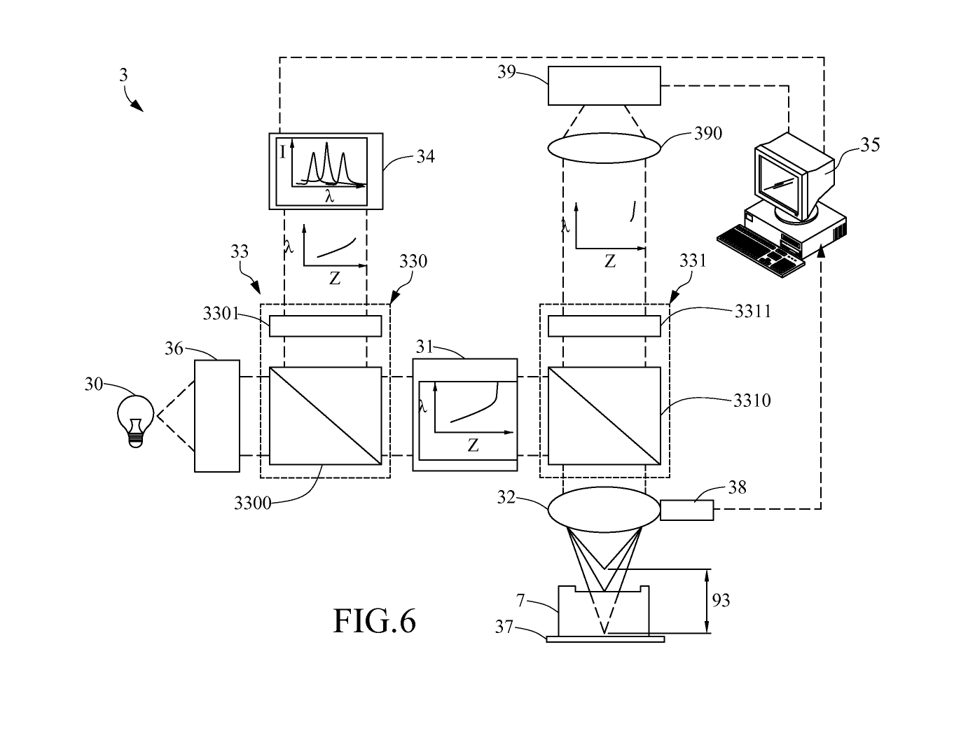

In addition, the aforesaid method for focusing in a focusing apparatus disclosed in FIG. 1 is applied in an apparatus for focusing which is also provided in the present disclosure. Please refer to FIG. 6, which is a schematic diagram showing an apparatus for focusing according to a first embodiment of the present disclosure. In FIG. 6, the apparatus for focusing 3 is comprised of a light source module 30, a dispersion module 31, an objective lens 32, a beam splitting/filtering element 33, an analyzer 34 and a control unit 35. The light source module, which is used for providing a broadband light, can be a white light source in this embodiment, but is not limited thereby. Moreover, for enhancing collimation, there can be a collimation lens 36 being disposed at a position between the beam splitting/filtering element 33 and the light source module 30. The dispersion module 31 is characterized by a dispersive curve, which includes a first dispersive band and a second dispersive band. In this embodiment, the dispersive curve can be constructed similar to those illustrated in FIG. 2A to FIG. 2D, and thus is not described further herein. The dispersion module 31 is for modulating the broadband light into a dispersive light, which is composed of beams of different wavelengths that are scattered along an optical axis at different locations corresponding thereto.

The objective lens 32 is used for focusing the dispersive light while projecting the same onto an object 7 so as to form an object light, whereas the object 7 can be an object to be measured or a platform 37 for carrying objects. As the dispersive light is composed of beams of different wavelengths that are focused at positions of different depths by the objective lens 32, thus a focus range 93 is achieved. It is noted that by the cooperation of the dispersion module 31 and the objective lens 32, it is able to achieve different focus ranges. In addition, the dispersion module 31 and the objective lens 32 are two independent units as illustrated in the embodiment shown in FIG. 6, however, they can be integrated into a dispersion objective lens in another embodiment. In this embodiment, the objective lens 32 is further coupled to a linear actuator 38, which can be a linear motor or a piezoelectric driver, but is not limited thereby. As the construction and operation of the linear actuator 38 are known to those skilled in the art and thus will not be described further herein. The linear actuator 38 is used for controlling the objective lens 32 to move and thus adjusting a distance between the objective lens 32 and the object 7. In another embodiment, the linear actuator 38 is coupled to the platform 37, by that the height as well as the position of the platform 37 can be controlled thereby so as to adjust the distance between the objective lens 32 and the object 7.

As shown in FIG. 6, the beam splitting/filtering element 33 is composed of a first beam splitting filter 330 and a second beam splitting filter 331, in which the first beam splitting filter 330 is disposed at a position between the light source module 30 and the dispersion module 31, and the second beam splitting filter 331 is disposed at a position between the objective lens 32 and the image sensor 39. Moreover, the first beam splitting filter 330 further includes: a first beam splitter 3300, being disposed at a position between the light source module 30 and the dispersion module 31; and a first filter 3301, being disposed at a position between the first beam splitter 3300 and the analyzer 34. In this embodiment, the first beam splitter 3300 is a beam splitting lens, and the first filter 3301 is designed for filtering beams corresponding to the first dispersive band, so that the first filter 3301 can be selected to be a high-pass filter or a low-pass filter according to the dispersive curve of the dispersion module 31.

Similarly, the second beam splitting filter 331 also includes: a second beam splitter 3310, being disposed at a position between the dispersion module 31 and the objective lens 32; and a second filter 3311, being disposed at a position between the second beam splitter 3310 and the image sensor 39. In this embodiment, the second beam splitter 3310 is a beam splitting lens, and the second filter 3311 is designed for filtering beams corresponding to the second dispersive band, so that the second filter 3301 can be selected to be a high-pass filter, a band-pass filter or a low-pass filter according to the dispersive curve of the dispersion module 31. Moreover, the analyzer 34, being a spectroscope, is disposed at a side of the first beam splitting filter 330, whereas the image sensor 39 is disposed at a side of the second beam splitting filter 331. In this embodiment, there is further a lens 390 being disposed between the image sensor 39 and the second beam splitting filter 331, and the image sensor 39 can be a complementary metal-oxide-semiconductor (CMOS) image sensor or a charged coupled device (CCD) image sensor. In addition, the control unit 35 is coupled to the image sensor 39, the linear actuator 38 and the analyzer 34, which can be a device selected from the group consisting of: computers and other devices with calculation and processing abilities.

The apparatus for focusing 3 illustrated in the first embodiment shown in FIG. 6 is designed to operation according to the steps depicted in the flow chart of FIG. 1. In the following description, the dispersion module 31 is featured by the dispersive curve illustrated in FIG. 2B. As the broadband light emitted from the light source module 30 is projected onto the first beam splitter 3300, it is directed to the dispersion module 30 where it is being dispersed into the dispersion light composed of beams relating to the first dispersive band and beams relating to the second dispersive band. The dispersion light is then being directed to the objective lens 32 by the second beam splitter 3310 where it is focused on the object 32 and thus reflected so as to form the object light. Thereafter, the object light is divided into a first object beam and a second object beam by the second beam splitter 3310 while enabling the first object beam to travel passing the dispersion module 31 and enter the first beam splitter 3300 where it is directed toward the first filter 3301 to be filtered and transformed into a beam corresponding to the first dispersive band, i.e. a filtered light containing only beams whose wavelengths are corresponding to the first dispersive band are allowed to pass through the first filter 3301 while the others are blocked. Thereby, the filtered light containing only beams whose wavelengths are corresponding to the first dispersive band will enter the analyzer 34 to be used in a spectrum analysis operation for obtaining a central wavelength relating to the height information of the surface profile of the object. It is noted that the central wavelength is a wavelength selected from the group consisting of: the wavelength corresponding to the maximum light intensity of the filtered light, and the wavelength with representative height information that is obtained from a numerical calculation. The following description uses the wavelength corresponding to the maximum light intensity of the filtered light as the central wavelength for illustration.

The signal containing information relating to the central wavelength of the maximum light intensity is transmitted to the control unit 35 to be used in a calculation for obtaining the height information relating to the surface profile of the object. As soon as the height information is obtained, the control unit 35 will base upon the height information to issue a control signal to the linear actuator 38. The linear actuator 38 is used for changing the distance between the objective lens 32 and the object 7 by adjusting the position of the objective lens 32, so as to focus the beams in the dispersion light corresponding to the second dispersive band onto the surface of the object 7. In another embodiment, the linear actuator 38 is coupled to the platform 37, by that the height as well as the position of the platform 37 can be controlled thereby according to the control signal so as to adjust the distance between the objective lens 32 and the object 7. Thereafter, the object light reflected from the object 7 will enter the second beam splitter 3310 again for enabling only the second object light in the object light to enter the second filter 3311 so as to form a second filtered light corresponding to the second dispersive band since the second filter 3311 is designed for allowing beams whose wavelengths are corresponding to the second dispersive band to pass therethrough. Then, the second filtered light is converged by the lens 390 and projected onto the image sensor 39 so as to form a clear and focused image of the object.

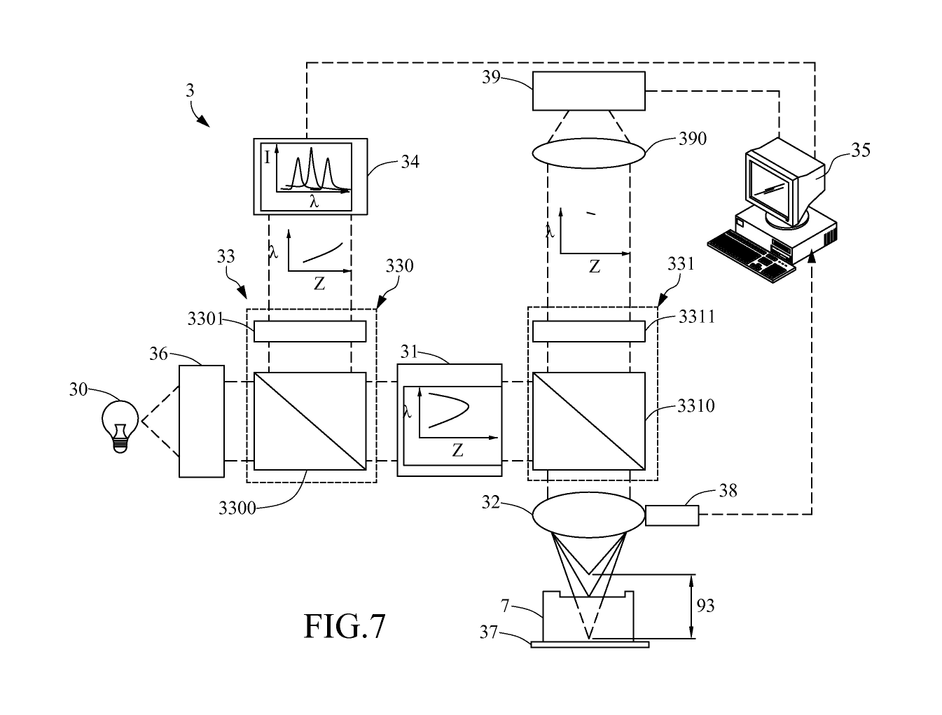

Please refer to FIG. 7, which is a schematic diagram showing an apparatus for focusing according to a second embodiment of the present disclosure. The apparatus for focusing of the second embodiment is basically the same as the one disclosed in the first embodiment, but is different in that: the dispersion module in the second embodiment is featured by the dispersive curve shown in FIG. 2D, in that the characteristic of its second dispersive band is different from those disclosed in FIG. 2A and FIG. 2B, and thus, the second filter 3311 in the embodiment shown in FIG. 7 is selected to be a band-pass filter so as to allow only a portion of the upper curve in the dispersive curve of FIG. 2D whose wavelengths are in the range of λ₀±Δλ to pass therethrough. It is noted that the range is defined by a principle that: it should be defined for dispersing light in a dispersion range that is small enough for generating clear image. Similarly, after the information relating to the wavelength corresponding to the maximum light intensity is obtained from the analysis of the analyzer 34, either the objective lens 32 or the platform 37 can be moved accordingly for placing the object 7 at a position corresponding to the focused positions of the beams capable of passing through the filtering of the second filter 3311, and thereby, the second filtered light passing through the second filter 3311 will focus on the object 7 where it is reflected to the image sensor 39 so as to form a clear image of the object 7.

With the method and apparatus for focusing of the present disclosure, not only the height information relating to the surface profile of an object can be obtained, but also a clear and focused image of the object can be acquired according to the height information without being affected by ambient vibration. It is noted that except for panel inspection, the method and apparatus for focusing of the present disclosure can be used in other automatic optical inspection processes

The disclosure being thus described, it will be obvious that the same may be varied in many ways. Such variations are not to be regarded as a departure from the spirit and scope of the disclosure, and all such modifications as would be obvious to one skilled in the art are intended to be included within the scope of the following claims.

What is claimed is:

1. A method for focusing in a focusing apparatus, comprising the steps of:
providing a dispersion module characterized by a dispersion curve including a first dispersive band and a second dispersive band;
enabling a broadband light to travel passing through the dispersion module so as to form a dispersion light in a manner that the dispersion light is projected on an object so as to form an object light;
analyzing the spectrum of the object light at a portion thereof relating to the first dispersive band for obtaining a height information of the surface profile of the object;
enabling the portion of the dispersion light relating to the second dispersive band to focus onto the object according to the height information; and
sensing the object light at a portion thereof relating to the second dispersive band so as to obtain a focused image.

2. The method of claim 1, wherein the analysis process for obtaining the height information of the surface profile of the object further comprises the steps of:
using a filtering element designed corresponding to the first dispersive band to filter the object light so as to formed a filtered light;
performing a spectrum analysis operation upon the filtered light so as to obtain a central wavelength relating to a height information of the surface profile of the object; and
performing a calculation according to a depth of a focused position resulting from the central wavelength so as to obtain the height information.

3. The method of claim 2, wherein the central wavelength is a wavelength selected from the group consisting of: the wavelength corresponding to the maximum light intensity of the filtered light, and the wavelength with representative height information that is obtained from a numerical calculation.

4. The method of claim 1, wherein the sensing of the object light at a portion thereof relating to the second dispersive band further comprises the steps of:
using another filtering element designed corresponding to the second dispersive band to filter the object light so as to formed another filtered light and
using an image sensor to sense the filter light so as to form the focused image.

5. The method of claim 4, wherein the filtering element is a filter selected from the group consisting of: a band-pass filter, a high-pass filter and a low-pass filter.

6. The method of claim 1, wherein the dispersive curve includes a first curve section, and a second curve section; and the dispersion characteristic of the first curve section is opposite to that of the second curve section; and the first curve section is specified to be the first dispersive band while specifying a portion of the second curve section within a specific wavelength range to be the second dispersive band.

7. The method of claim 1, wherein the dispersive curve includes a first curve section, and a second curve section; and the dispersion range of the second curve section is smaller than that of the first curve section; and the first curve section is specified to be the first dispersive band while the second curve section is specified to be the second dispersive band.

8. An apparatus for focusing, comprising:
a light source module, for providing a broadband light;
a dispersion module, characterized by a dispersion curve including a first dispersive band and a second dispersive band, provided for modulating the broadband light into a dispersive light;
an objective lens, for focusing the dispersive light while projecting the same onto an object so as to form an object light;
a beam splitting/filtering element, for splitting the object light into a first object beam and a second object beam while filtering the two so as to form a first filtered beam corresponding to the first dispersive band and a second filtered beam corresponding to the second dispersive band;
an analyzer, for performing a spectrum analysis operation upon the first filtered beam so as to obtain a central wavelength relating to a height information of the surface profile of the object;
a control unit, for performing a calculation according to the central wavelength so as to obtain the height information to be used for adjusting the distance between the objective lens and the object and thus enabling the portion of the dispersion light relating to the second dispersive band to focus onto the object; and
an image sensor, for sensing the second filtered beam so as to form a focused image.

9. The apparatus of claim 8, wherein the central wavelength is a wavelength selected from the group consisting of: the wavelength corresponding to the maximum light intensity of the filtered light, and the wavelength with representative height information that is obtained from a numerical calculation.

10. The apparatus of claim 8, wherein the beam splitting/filtering element further comprises:
a first beam splitting filter, disposed at a position between the light source module and the dispersion module, for guiding the broadband light to the dispersion module and capable of filtering the first object beam so as to form the first filtered beam; and
a second beam splitting filter, disposed at a position between the objective lens and the image sensor, for splitting the object light to the first object beam and the second object beam and capable of filtering the second object beam so as to form the second filtered beam.

11. The apparatus of claim 10, wherein the first beam splitting filter further comprises:
a first beam splitter, disposed at a position between the light source module and the dispersion module, for guiding the broadband light to the dispersion module; and
a first filter, configured with a filtering characteristic corresponding to the first dispersive band, capable of filtering the first object beam so as to form the first filtered beam.

12. The apparatus of claim 11, wherein the first filter is a filter selected from the group consisting of: a band-pass filter, a high-pass filter and a low-pass filter.

13. The apparatus of claim 10, wherein the second beam splitting filter further comprises:
a second beam splitter, disposed at a position between the objective lens and the image sensor, for splitting the object light to the first object beam and the second object beam; and
a second filter, configured with a filtering characteristic corresponding to the second dispersive band, capable of filtering the second object beam so as to form the second filtered beam.

14. The apparatus of claim 13, wherein the second filter is a filter selected from the group consisting of: a band-pass filter, a high-pass filter and a low-pass filter.

15. The apparatus of claim 8, further comprising:
a linear actuator, coupled to the objective lens, capable of according to a control signal issued from the control unit to adjust a distance between the objective lens and the object.

16. The apparatus of claim 8, further comprising:
a linear actuator, coupled to a platform provided for carrying the object, capable of enabling the platform to move according to a control signal issued from the control unit, and thus adjusting a distance between the objective lens and the object.

17. The apparatus of claim 8, wherein the dispersion module is integrated with the objective lens into a dispersion objective lens.

18. The apparatus of claim 8, wherein the dispersive curve includes a first curve section, and a second curve section; and the dispersion characteristic of the first curve section is opposite to that of the second curve section; and the first curve section is specified to be the first dispersive band while specifying a portion of the second curve section within a specific wavelength range to be the second dispersive band.

19. The apparatus of claim 8, wherein the dispersive curve includes a first curve section, and a second curve section; and the dispersion range of the second curve section is smaller than that of the first curve section; and the first curve section is specified to be the first dispersive band while the second curve section is specified to be the second dispersive band.
